(19) United States
(12) Patent Application Publication
(10) Pub. No.: US 2012/0188916 A1
(43) Pub. Date: Jul. 26, 2012

(54) WIRELESS DEVICE, WIRELESS APPARATUS USING SAME, AND WIRELESS SYSTEM

(76) Inventors: Eiji Miyake, Kyoto (JP); Michiaki Tsuneoka, Osaka (JP); Hiroki Kaihori, Osaka (JP)

(21) Appl. No.: 13/383,217

(22) PCT Filed: Aug. 27, 2010
(86) PCT No.: PCT/JP2010/005290

§ 371 Date: Jan. 10, 2012

(30) Foreign Application Priority Data
Sep. 30, 2009 (JP) 2009-226930

(51) Int. Cl. H04B 7/005; H04B 1/54

(52) U.S. Cl. 370/277

(57) ABSTRACT

A wireless device wherein a first reception block carries out carrier sensing operation to check a condition of interfering wave before a first transmission block transmits a signal, and the first reception block halts operation thereof and makes the first transmission block transmit the signal when the first reception block confirms that the condition of interfering wave is within a predetermined range, or executes retry operation for carrying out the career sensing operation again when it confirms that the condition of interfering wave is outside of the predetermined range as a result of the career sensing operation.

### TECHNICAL FIELD

The present invention relates to a wireless device for transmitting and receiving a signal with a master unit, a wireless apparatus using the same, and a wireless system also using the same.

### BACKGROUND ART

Description is provided of a conventional wireless system. In a conventional wireless system, a master unit and a slave unit (wireless apparatus) transmit and receive signals with each other over the air. A frequency band used by the master unit to transmit a signal to the wireless apparatus is the same frequency band as used by the wireless apparatus to transmit a signal to the master unit.

When the master unit is directed to control specified operation of the wireless apparatus, a controller of the master unit generates a modulated signal (i.e., a signal inside the above frequency band) including an intended control command, and transmits it to the wireless apparatus via an antenna. Upon receipt of the modulated signal with an antenna of the wireless apparatus, it is demodulated by a controller. The controller of the wireless apparatus identifies the control command transmitted from the master unit, and carries out the specified operation corresponding to the control command.

In the conventional wireless system of such kind wherein the master unit controls specified operation of the wireless apparatus, the wireless apparatus must be in a receiving mode whenever the master unit goes into transmitting operation in order for the wireless apparatus to demodulate the modulated signal transmitted from the master unit and to determine the control command. Since the master unit repeats transmitting operation and receiving operation alternately, the wireless apparatus needs to keep a receiving unit to operate for a longer period of time than a time duration in which the master unit transmits the signal for the purpose of providing a leeway. It is for this reason that the wireless apparatus has a problem that it consumes a large power during this operation.

Patent literature 1, for example, is one of the technical documents known to be relevant to the discussed prior art.

### CITATION LIST

### Patent Literature 1

Japanese Patent Unexamined Publication, No. 1996-265823

### SUMMARY OF THE INVENTION

The present invention addresses the above problem and achieves a wireless device capable of making a master unit control operation of a wireless apparatus with small power consumption, and the wireless apparatus that uses this wireless device and also a wireless system that uses this wireless device.

The wireless device of the present invention comprises a first reception block and a first transmission block for transmitting and receiving radio signals in the same frequency band, wherein the first reception block performs carrier sensing operation to check a condition of interfering wave in the frequency band before the first transmission block transmits a signal, the first reception block halts the operation and makes the first transmission block transmit the signal when the first reception block confirms that the condition of interfering wave is within a predetermined range as a result of the career sensing operation, the first reception block halts the operation when the first reception block confirms that the condition of interfering wave is outside of the predetermined range as the result of the career sensing operation and executes retry operation for carrying out the career sensing operation again after a lapse of predetermined time, and at least one of the first reception block and the first transmission block carries out a predetermined operation when the retry operation is repeated a given number of times.

### BRIEF DESCRIPTION OF THE DRAWINGS

FIG. 1 is a block diagram showing a structure of a wireless system according to an exemplary embodiment of the present invention;

FIG. 2 is an explanatory graph depicting time interval T1 of career sensing operation when retry operation is not performed, according to the exemplary embodiment of this invention; and

FIG. 3 is another explanatory graph depicting time interval T2 of career sensing operation when retry operation is performed, according to the exemplary embodiment of this invention.

### DETAILED DESCRIPTION OF THE INVENTION

### Exemplary Embodiment

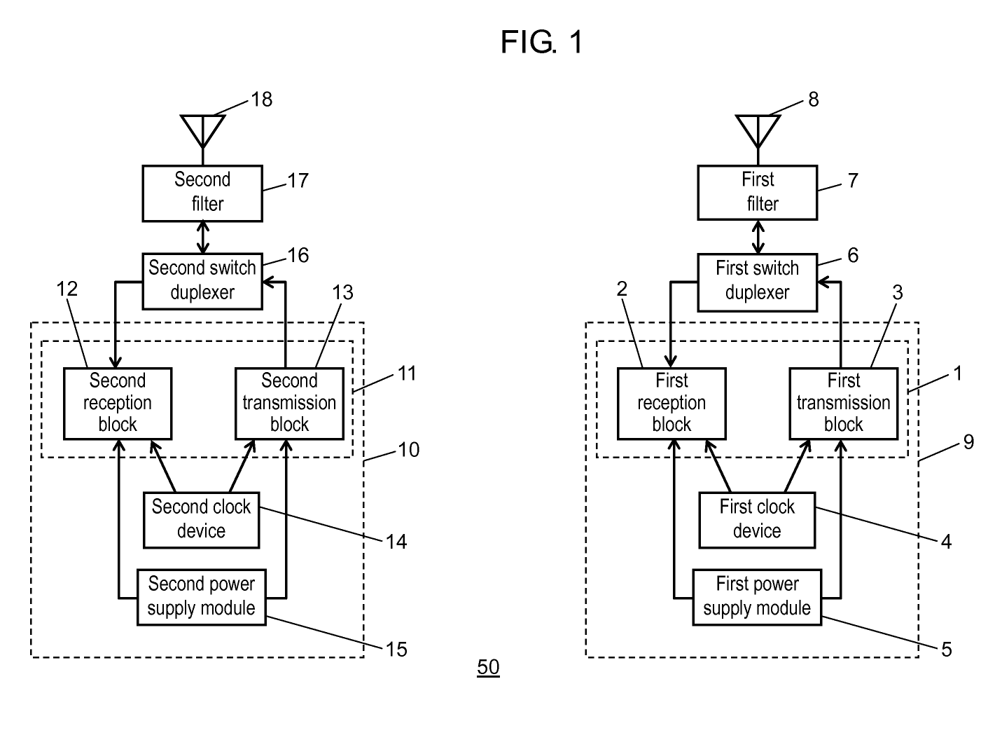

Referring to the drawings description is provided hereinafter in detail of a wireless device, a wireless apparatus using the same, and a wireless system also using the same according to an embodiment the present invention. FIG. 1 is a block diagram showing a structure of the wireless system in the exemplary embodiment of this invention. Wireless system 50 comprises master unit 10 and wireless apparatus 9 used as a slave unit, as shown in FIG. 1.

Wireless apparatus 9 comprises first wireless device 1 having first reception block 2 and first transmission block 3, first clock device 4 for transmitting clock to first reception block 2 and first transmission block 3, and first power supply module 5 for supplying electric power to at least first reception block 2 and first transmission block 3. First reception block 2 and first transmission block 3 are connected to first switch duplexer 6. First switch duplexer 6 is connected to first filter 7, and first filter 7 is connected to first antenna 8.

Master unit 10 comprises second wireless device 11 having second reception block 12 and second transmission block 13, second clock device 14 for transmitting clock to second reception block 12 and second transmission block 13, and second power supply module 15 for supplying electric power to at least second reception block 12 and second transmission block 13. Second reception block 12 and second transmission block 13 are connected to second switch duplexer 16. Second switch duplexer 16 is connected to second filter 17, and second filter 17 is connected to second antenna 18.

Master unit 10 and wireless apparatus 9 transmit and receive signals with each other over the air. A frequency band used when master unit 10 transmits a signal to wireless apparatus 9 is the same frequency band used when wireless apparatus 9 transmits a signal to master unit 10, which is designates as frequency band A.

Accordingly, filters having same characteristics can be used for both first filter 7 and second filter 17. In addition, antennas having same characteristics can be used for first antenna 8 and second antenna 18. Furthermore, switch duplexers having same characteristics can also be used for first switch duplexer 6 and second switch duplexer 16.

First switch duplexer 6 has the function of temporally switching between first reception block 2 and first transmission block 3 for connection to first filter 7. Similarly, second switch duplexer 16 has the function of temporally switching between second reception block 12 and second transmission block 13 for connection to second filter 17.

First power supply module 5 comprises a battery, and wireless apparatus 9 is designed to be smaller in size as compared with master unit 10. Wireless apparatus 9 may also include a sensor element (not shown) connected at least to first transmission block 3. A detection data taken by the sensor element is input to the first transmission block 3 from the sensor element at any given time. Here, the sensor element includes a small sensor unit for detecting any of living body information such as a human body and animal, a condition of surrounding environment, and the like.

The detection data is transmitted to second antenna 18 through first switch duplexer 6, first filter 7 and first antenna 8 by using the frequency band stated above, and the data is recorded in a storage device (not shown) provided in master unit 10.

First wireless device 1 carries out career sensing operation with first reception block 2 to check a condition of interfering wave in the frequency band A before transmitting from first transmission block 3 a signal of the detection data and the like detected by the sensor element. The career sensing operation is defined here as a task of checking a condition of interfering wave in the frequency band A being input to first reception block 2 through first antenna 8, first filter 7 and first switch duplexer 6. The condition of interfering wave in this specification refers to an average power level of the interfering wave, but it may be any of other indices such as an instantaneous power level of the interfering wave, a state of power distribution within the frequency band A and the like.

By carrying out the career sensing operation, it becomes possible to shorten an operating time of signal processing such as demodulation that requires a large amount of power consumption, in addition to an advantage of the career sensing operation itself capable of detecting the power value and the like with small power consumption. For this purpose, first reception block 2 may be so configured as to have a power detector circuit (not shown) used for the career sensing operation and a demodulator circuit (not shown) for receiving and demodulating signals from master unit 10 when establishing a link between master unit 10 and wireless apparatus 9, and operate only the power detector circuit during the career sensing operation. As a result, there can be achieved the wireless device of low power consumption.

Description is provided here of the reason for performing the career sensing operation to check the condition of interfering wave in the frequency band A with first reception block 2 before first wireless device 1 transmits a signal. In an instance where a large number of slave units exist besides wireless apparatus 9 that make wireless communications with master unit 10, there can be a situation that wireless apparatus 9 transmits a signal to master unit 10 by using the frequency band A when one of the slave units other than wireless apparatus 9 is in the middle of transmitting another signal by using the same frequency band A.

Since two signals exist at the same time in the frequency band A, it becomes impossible for master unit 10 to receive both of the signals under such a situation. In order to avoid this drawback, first wireless device 1 carries out career sensing operation prior to transmitting the signal and refrains from transmitting the signal when it detects any signal of other slave units (i.e., an interfering wave for wireless apparatus 9) within the frequency band A. While first reception block 2 is carrying out the career sensing operation, other unused circuit blocks (e.g., modulation circuit, sensor element and the like of first transmission block 3) can be kept not operated. This enables wireless apparatus 9 to reduce the power consumption.

First reception block 2 halts the operation when it confirms that the condition of the interfering wave existing in the frequency band A is within a predetermined range as a result of the career sensing operation, and first transmission block 3 sends a signal, which is hence transmitted to master unit 10 through first switch duplexer 6, first filter 7 and first antenna 8. This also achieves a reduction in the power consumption of the wireless apparatus since first reception block 2 halts the operation except only when it is necessary (e.g., during the career sensing operation), and first transmission block 3 also halts the operation except when it is necessary (e.g., during transmission of the signal).

The phrase of “the condition of the interfering wave existing in the frequency band A is within a predetermined range” indicates that the condition of the interfering wave is inside a range that allows wireless apparatus 9 and master unit 10 to make wireless communications in the frequency band A. It means, for instance, the interfering wave in the frequency band A detected by first reception block 2 during the career sensing operation is within a predetermined range, such as −80 dBm or below in an average power value. This range of values may be changed at any time as appropriate according to a variation in the use environment (e.g., a room temperature, a communication distance to master unit 10, and the like) of wireless apparatus 9. This helps maintain good wireless communications between master unit 10 and wireless apparatus 9.

When first reception block 2 confirms, on the other hand, that the condition of the interfering wave in the frequency band A is outside of the predetermined range as a result of the career sensing operation, first reception block 2 halts the operation. First reception block 2 then performs retry operation for carrying out the career sensing operation again after a lapse of predetermined time.

Here, the retry operation is defined as the task of first reception block 2 to carry out the career sensing operation again to determine whether the condition of interfering wave in the frequency band A is inside or outside of the predetermined range after a lapse of the predetermined time if first transmission block 3 does not proceed with transmission of the signal subsequent to halting the previous career sensing operation carried out by first reception block 2.

The retry operation carried out in this manner enables first wireless device 1 to find timing of initiating wireless communications smoothly with master unit 10.

Here, the term “predetermined time” indicates a period of time before first reception block 2 restarts the career sensing operation after it has halted the previous career sensing operation, if first transmission block 3 does not proceed with transmission of the signal following the halt of the previous career sensing operation by first reception block 2.

When first power supply module 5 comprises a battery, for instance, a possibility arises that wireless apparatus 9 becomes unstable because the battery voltage continues to decrease if the career sensing operation is kept repeated continuously without providing this predetermined time period. In the case of first wireless device 1, a power consumption of the battery can be reduced by halting the career sensing operation for the predetermined time period in a manner so that the battery can recover nearly the original voltage during this period from a voltage value dropped during the career sensing operation. This can hence stabilize the operation of wireless apparatus 9.

The predetermined time discussed above may either be a fixed value or any other value that can be changed at any time by first reception block 2 as appropriate according to a variation in the use environment (e.g., room temperature) of wireless apparatus 9, a change in the amount of stored energy of first power supply module 5, and the like. This is because a time period necessary for the battery to recover from the dropped voltage varies depending on the use temperature and amount of the remaining energy.

Wireless apparatus 9 of more stable operation can be achieved by adjusting the predetermined time at any time with consideration given to them. To achieve this advantage, first reception block 2 may be so configured that it is connected with a temperature sensor (not shown) and a battery's remaining energy sensor (not shown) provided in first power supply module 5.

First wireless device 1 carries out a predetermined operation when it has repeated the retry operation for a given number of times. The “predetermined operation” here includes any such operation as halting the operation and function of first reception block 2, halting the operation and function of first transmission block 3, either increasing or decreasing a transmission output of first transmission block 3 by a predetermined value, changing a characteristic of a low noise amplifier (not shown) in first reception block 2, and the like.

Assumption is made as one example that the predetermined operation of first wireless device 1 is “to increase the transmission output of first transmission block 3 by 4 dB when the interfering wave is confirmed to be within the predetermined range in a fourth retry operation after having repeated the retry operation three times (when a continued number of times of the retry operations becomes four times)”

In this instance, it is possible to create a condition in which the interfering wave falls within the predetermined range during the fourth retry operation of first reception block 2 of wireless apparatus 9 by having second transmission block 13 of master unit 10 transmit the interfering wave until first reception block 2 continues the retry operation three times, and halt the transmission of the interfering wave thereafter. Furthermore, second transmission block 13 is caused to transmit the interfering wave again after first reception block 2 completes the fourth retry operation to make first reception block 2 continue the retry operation three times, and halt the transmission of the interfering wave thereafter. This makes first transmission block 3 raise the transmission output by 4 dB every after continuation of the retry operation four times, according to the predetermined operation discussed above.

In the manner as described, master unit 10 can consequentially control first transmission block 3 to raise the transmission output at the rate of 4 dB. Master unit 10 controls the continued number of times of retry operations of first reception block 2 by adjusting and regulating a transmission time of the interfering wave. As a result, master unit 10 can control the operation of first wireless device 1. In order to carry out this control, master unit 10 needs to be provided in advance with information on time intervals of the retry operation continued by first reception block 2, specific details of the predetermined operation and the like.

For first wireless device 1, plural kinds of predetermined operations may be prepared, and these kinds of operations are assigned individually depending on the continued number of times of retry operations. For example, the operations may be so assigned that an NF (noise figure) characteristic of a low noise amplifier (not shown) in first reception block 2 is increased by 0.5 dB when the continued number of times of retry operations of first reception block 2 is three, and operation of first reception block 2 and first transmission block 3 is halted when the continued number of times of retry operations of first reception block 2 becomes four.

Accordingly, master unit 10 can flexibly control operation of wireless apparatus 9 by adjusting the transmission time of the interfering wave, thereby achieving wireless system 50 featuring enhanced usability.

It is also practical to change time intervals of the continued retry operations at any time. For example, the retry operation may be carried out twice at intervals of 0.3 seconds, and the retry operations may be continued at intervals of 0.15 seconds following the second retry operation.

When communications are being made between master unit 10 and a plurality of slave units, the probability of occurrence of the retry operation caused by transmission signals of other slave units decreases with increase in the continued number of times of retry operations. On the other hand, the probability of occurrence of the retry operation due to the interfering wave transmitted by master unit 10 for the purpose of controlling operation of the slave unit may remain at 100% with a high possibility of not to decrease until the control is executed even when the continued number of times of retry operations increases.

Thus, it can be said that the more the continued number of times of retry operations the higher the probability of master unit 10 to repeat making control of first wireless device 1. In this case, there is a little influence to wireless communications between master unit 10 and wireless apparatus 9 even if a frequency per unit time of performing the career sensing operations is increased (which means an increase in the number of the career sensing operations carried out within a given time, and it is equal to shortening the above-mentioned “predetermined time”), since the possibility remains low for the interfering wave of the frequency band A to fall within the predetermined range. It is thus possible to shorten a response time when master unit 10 controls operation of first wireless device 1 by increasing the frequency per unit time of the career sensing operations.

Similarly, it is appropriate to shorten the time interval of the career sensing operations with increase in the continued number of times of retry operations. This is also because the more the continued number of times of retry operations the higher the probability of master unit 10 to repeat making control of first wireless device 1. There is a little influence in this case to wireless communications between master unit 10 and wireless apparatus 9 even when the time interval of the career sensing operations is shortened since the possibility remains low for the interfering wave of the frequency band A to fall within the predetermined range. The response time can be thus shortened when master unit 10 controls operation of first wireless device 1 by shortening the time interval of the career sensing operations.

In addition, first wireless device 1 may be so configured that it has an upper limit set to the continued number of times of retry operations, so that operation of first wireless device 1 is compulsory changed to a predetermined operation when the continued number of times of retry operations reaches the upper limit (i.e., when the condition of the interfering wave is outside of the predetermined range even after the retry operations are carried out consecutively to the upper limit).

Assuming, for instance, that the upper limit for the continued number of times of retry operations is set to five times, and the specified operation assigned to first wireless device 1 in this instance is to increase a consuming current of first reception block 2 by 0.1 mA. In this case, when master unit 10 is to increase the consuming current of first reception block 2 by 0.3 mA, only what is needed for master unit 10 is to have second transmission block 13 continue transmission of the interfering wave for a period sufficient to allow at least fifteen times of consecutive retry operations. When the specified operation is predetermined in this manner, it becomes unnecessary for second transmission block 13 to perform complex operation such as transmitting the interfering wave only for a period enough to allow four consecutive retry operations, halting the transmission of the interfering wave momentarily during the fifth retry operation (to have determination that the retry operations have been five times), and again transmitting the interfering wave thereafter.

The configuration of setting the upper limit to the continued number of times of retry operations is especially useful when the specified operation predetermined for first wireless device 1 is to halt the functions of both first reception block 2 and first transmission block 3. This is because it is not conceivable that first wireless device 1 is controlled further by master unit 10 when both first reception block 2 and first transmission block 3 are in a state of halting their functions.

It is assumed that wireless apparatus 9 has the structure shown in FIG. 1 that comprises first wireless device 1, first clock device 4 connected with first reception block 2 and first transmission block 3, and first power supply module 5 connected with first wireless device 1 and first clock device 4. In this structure, a clock of first clock device 4 may be used to differentiate between time interval T1 of career sensing operation when the retry operation is not performed and another time interval T2 of career sensing operation when the retry operation is performed.

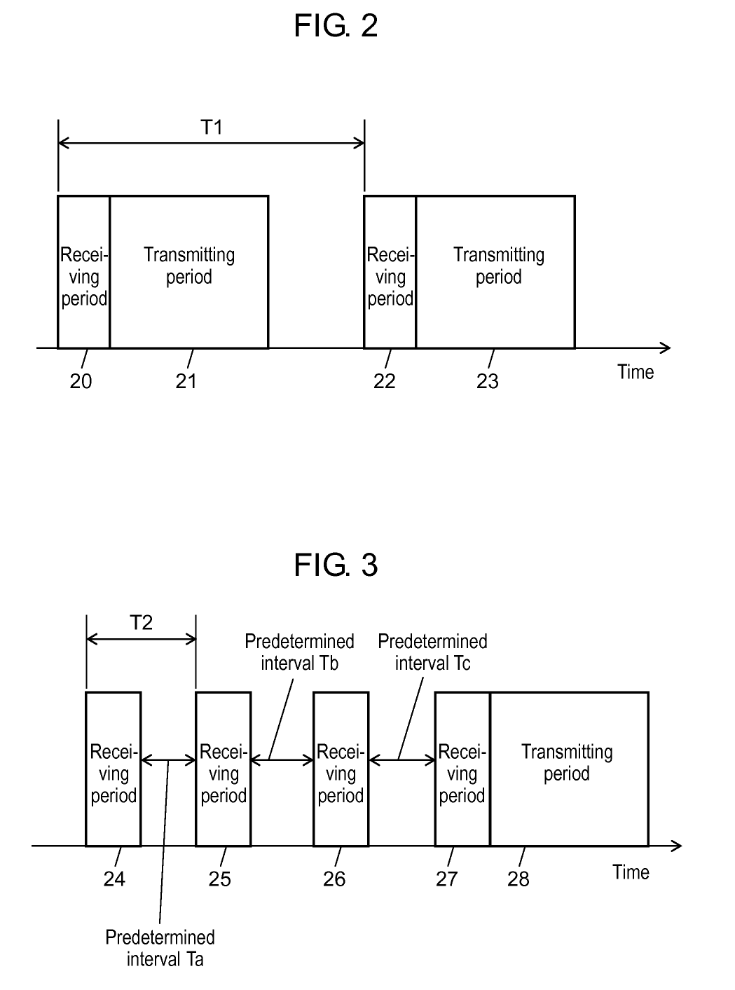

Description is provided here about “time interval T1 of career sensing operation when the retry operation is not performed” and “time interval T2 of career sensing operation when the retry operation is performed” with reference to the accompanying drawings. FIG. 2 is an explanatory graph depicting time interval T1 of career sensing operation when the retry operation is not performed, and FIG. 3 is another explanatory graph depicting time interval T2 of career sensing operation when the retry operation is performed, according to this exemplary embodiment of the invention. In both FIG. 2 and FIG. 3, the horizontal axis represents time to show changes in the operation with time of first wireless device 1.

In an example shown in FIG. 2, it is assumed that a condition of the interfering wave has not been confirmed as to be outside of the predetermined range (i.e., confirmed to be within the predetermined range) when first reception block 2 has performed the career sensing operation during receiving period 20. In this case, first transmission block 3 of wireless apparatus 9 sends a data detected by the sensor element or the like to first switch duplexer 6 during transmitting period 21 following the receiving period 20. First reception block 2 stays not in operation during transmitting period 21. In addition, first transmission block 3 and first reception block 2 stay not operating in the period from the end of transmitting period 21 to the subsequent start of receiving period 22.

Time period T1 from the starting point of receiving period 20 to the starting point of next receiving period 22 in FIG. 2 is defined as “time interval T1 of the career sensing operation when the retry operation is not performed”. In the example of FIG. 2, the data is transmitted again during transmitting period 23 following receiving period 22.

In an example shown in FIG. 3, it is assumed that first reception block 2 has confirmed that a condition of interfering wave in the frequency band A is outside of the predetermined range when it performs the career sensing operation during receiving period 24. In this case, first reception block 2 momentarily halts the career sensing operation at the end of receiving period 24, and restarts the career sensing operation again after a lapse of predetermined interval Ta (i.e., at the starting point of receiving period 25). This is the retry operation.

If the condition of interfering wave in the frequency band A is still outside of the predetermined range in the career sensing operation during receiving period 25, first reception block 2 momentarily halts the career sensing operation at the end of receiving period 25, and restarts the career sensing operation again after a lapse of predetermined interval Tb (i.e., at the starting point of receiving period 26). This is the second of consecutive retry operations.

If the condition of interfering wave in the frequency band A is still outside of the predetermined range in the career sensing operation during receiving period 26, first reception block 2 momentarily halts the career sensing operation at the end of receiving period 26, and restarts the career sensing operation once again after a lapse of predetermined interval Tc (i.e., at the starting point of receiving period 27). This is the third of consecutive retry operations.

In the example shown in FIG. 3, first reception block 2 finds the condition of interfering wave in the frequency band A as being inside of the predetermined range in the career sensing operation during receiving period 27, and it therefore stops the career sensing operation after the end of receiving period 27. First transmission block 3 then transmits a signal to first switch duplexer 6 immediately after the start of transmitting period 28. As a result, a continued number of times of the retry operations is settled at three times, and first wireless device 1 carries out the specified operation predetermined as the task to be executed when the continued number of times of the retry operations is three.

By virtue of using the continued number of times of retry operations of the career sensing, wireless apparatus 9 becomes capable of controlling the specified operation by operating first reception block 2 for only a short time, thereby achieving wireless system 50 that can control wireless apparatus 9 with small power consumption.

Note that “predetermined interval” discussed above represents each of the intervals Ta, Tb and Tc shown in FIG. 3. As stated, these intervals Ta, Tb and Tc may be the same length of time, or they can be different from one another. It is also practical to shorten the predetermined interval with increase in the continued number of times of the retry operations (Ta>Tb>Tc) to speed up the response of master unit 10 to control wireless apparatus 9. On the other hand, the predetermined interval may be extended with increase in the continued number of times of the retry operations (Ta<Tb<Tc) to thereby improve accuracy of the career sensing operation.

In addition, the predetermined interval may be adjusted according to the condition of the interfering wave in each of the career sensing operations. It is conceivable that the predetermined interval is set longer when an average receiving power of the interfering wave becomes larger, for instance. Accordingly, the time period T2 from the starting point of receiving period 24 to the starting point of receiving period 25 in FIG. 3 is defined as “time interval T2 of the career sensing operation when the retry operation is performed”.

In the case where there are first and second slave units in the vicinity of master unit 10 (both the first slave unit and the second slave unit are also assumed to be close to each other), for instance, and assume that first wireless device 1 representing the first slave unit is performing the operation as shown in FIG. 2. Also assume, on the other hand, that the second slave unit is performing the operation shown in FIG. 3, and that the starting point of receiving period 24 of FIG. 3 falls within transmitting period 21 of FIG. 2.

If the time period T1 and time period T2 are equal under this condition, the second slave unit receives only the signal transmitted by the first slave unit at all the time during the career sensing operation even when it repeats the retry operation a plural number of times (i.e., under the condition that the first slave unit does not performs retry operation). This makes the master unit unable to control the specified operation of the second slave unit on the basis of the continued number of times of retry operations. The time period T1 and time period T2 are therefore set different in their lengths in order to avoid a condition that the second slave unit keeps receiving the signal transmitted from the first slave unit.

In the wireless system provided with master unit 10 and a plurality of slave units (i.e., wireless apparatuses 9), it is still possible by differentiating between time periods T1 and T2 to achieve the wireless system capable of controlling operation of the plurality of slave units (wireless apparatuses 9) while maintaining small power consumption of the slave units (wireless apparatuses 9).

In the structure shown in FIG. 1, a component desirable for use as first clock device 4 can be an oscillator device whose clock accuracy is lower than any of quartz oscillator, ceramic oscillator and SAW (surface-acoustic-wave) oscillator.

The reason of this is as follows. In the wireless system having master unit 10 and a plurality of slave units (i.e., a plurality of wireless apparatuses 9), it so occurs that the plurality of slave units transmit their signals at the same time to master unit 10 during transmitting periods 21, if time periods T1 (refer to FIG. 2) of the plurality of slave units are of the same length, and the starting points of their receiving periods 20 (refer to FIG. 2) are simultaneous. It thus becomes impossible for master unit 10 to receive the signals from the plurality of slave units since these signals interfere with one another.

When one of quartz oscillator, ceramic oscillator and SAW oscillator is used here as first clock device 4 for each of the plurality of slave units, the starting points of their receiving periods 22 (refer to FIG. 2) also become simultaneous because of very high accuracy of their clocks. A result of this is for the plurality of slave units (i.e., plurality of wireless apparatuses 9) to transmit their signals simultaneously to master unit 10 during transmitting periods 23.

Here, the individual clocks of the plurality of slave units can be shifted to some extent by using first clock devices 4 made of oscillator devices of lower clock accuracy than any of quartz oscillator, ceramic oscillator and SAW oscillator, which in turn shift receiving periods 22 among the plurality of slave units (refer to FIG. 2), thereby preventing the plurality of slave units from transmitting the signals simultaneously. The oscillator device for use as first clock device 4 may be a combination of a resistor and a capacitor (i.e., a C-R oscillation circuit), a combination of an inductor and a capacitor (an L-C oscillation circuit), and the like.

As discussed above, wireless system 50 of this embodiment comprises wireless apparatus 9 and master unit 10 that makes wireless communications with wireless apparatus 9. Master unit 10 has second transmission block 13 and second reception block 12. When wireless apparatus 9 has a sensor element connected to first transmission block 3, a signal detected by the sensor element is transmitted from first transmission block 3 and received by second reception block 12 of master unit 10. When master unit 10 is to control the operation of wireless apparatus 9, second transmission block 13 of master unit 10 transmits interfering wave to first reception block 2 of wireless apparatus 9. Master unit 10 can control wireless apparatus 9 by adjusting intervals of transmitting the interfering wave.

Since wireless apparatus 9 can shorten the time of receiving operation by virtue of this configuration, it becomes possible to operate with a low power by using a small coin battery, thereby achieving a reduction in size of wireless apparatus 9.

The interfering wave may be a CW wave (continuous wave) within the frequency band A, or it can be a wide-band signal covering the frequency band A. In short, the interference may be in any form that can be determined as to be outside of the predetermined range during the career sensing operation.

Second transmission block 13 of master unit 10 may be so configured that it basically does not operate except for two periods, when it transmits an address data, etc. in the process of establishing a link with a slave unit such as wireless apparatus 9, and when it transmits interfering wave in the frequency band A for controlling the slave unit.

Likewise, first reception block 2 of the slave unit such as wireless apparatus 9 may be so configured that it basically does not operate except for two periods, when it receives the address data, etc. in the process of establishing the link with master units 10, and when it carries out career sensing operation.

It is by virtue of this configuration to shorten the duration of receiving signals that consumes a large current. This can make wireless apparatus 9 operable with a small battery or the like, thereby achieving a substantial reduction in size of wireless apparatus 9.

The term “connection” used in this specification refers to an electrically connected state, and this term not only covers a condition of electrical DC connection but also a condition of electromagnetic coupling.

Moreover, master unit 10 in wireless system 50 of this embodiment has the structure similar to that of wireless apparatus 9 operating as a slave unit, as shown in FIG. 1. This structure makes not only the master unit capable of controlling the slave unit but also the slave unit capable of controlling the master unit.

### INDUSTRIAL APPLICABILITY

As has been discussed, what can be achieved according to the present invention is a wireless system having a master unit capable of controlling operation of a wireless apparatus with small power consumption, and the invention is therefore useful for a wireless device for transmitting and receiving signals with the master unit, a wireless apparatus that uses this wireless device and the wireless system that also uses this wireless device.

### REFERENCE MARKS IN THE DRAWINGS

1 First wireless device
2 First reception block
3 First transmission block
4 First clock device
5 First power supply module
6 First switch duplexer
7 First filter
8 First antenna
9 Wireless apparatus
10 Master unit
11 Second wireless device
12 Second reception block
13 Second transmission block
14 Second clock device
15 Second power supply module
16 Second switch duplexer
17 Second filter
18 Second antenna
20, 22, 24 to 27 Receiving period
21, 23, 28 Transmitting period
50 Wireless system

1. A wireless device comprising a first reception block and a first transmission block for transmitting and receiving radio signals in the same frequency band, wherein:
the first reception block carries out a carrier sensing operation to check a condition of interfering wave in the frequency band before the first transmission block transmits a signal;
the first reception block halts an operation thereof and the first transmission block transmits the signal when the first reception block confirms that the condition of interfering wave is within a predetermined range as a result of the career sensing operation;
the first reception block halts the operation thereof when the first reception block confirms that the condition of interfering wave is outside of the predetermined range as the result of the career sensing operation, and executes a retry operation for carrying out the career sensing operation again after a lapse of predetermined time period; and
at least one of the first reception block and the first transmission block carries out a predetermined operation when the retry operation is repeated a predetermined number of times.

2. The wireless device of claim 1, wherein:
the first reception block avoids carrying out the retry operation further when the condition of interfering wave is outside of the predetermined range although the retry operation is repeated a predetermined number of times; and
both the first reception block and the first transmission block halt respective operations thereof.

3. The wireless device of claim 1, wherein the first reception block shortens the predetermined time period as a number of times of the continuous retry operations.

4. The wireless device of claim 1, wherein the first reception block shortens a time period of the career sensing operations as a number of times of the continuous retry operations.

5. A wireless apparatus comprising:
the wireless device of claim 1;
a clock device connected with the first reception block and the first transmission block; and
a power supply module connected to the wireless device,
wherein the first reception block differentiates time interval T2 between the career sensing operations when the retry operation is performed from another time interval T1 between the career sensing operations when the retry operation is not performed.

6. The wireless apparatus of claim 5, wherein the clock device comprises an oscillator device having a clock accuracy lower than that of a quartz oscillator, a ceramic oscillator and an SAW oscillator.

7. A wireless system comprising the wireless apparatus of claim 5 and a master unit for making wireless communications with the wireless apparatus, wherein:
the master unit comprises a second transmission block and a second reception block;
the first transmission block of the wireless apparatus transmits a signal;
the second reception block of the master unit receives the signal;
the second transmission block transmits an interfering wave to the first reception block of the wireless apparatus when the master unit controls an operation of the wireless apparatus; and
the master unit controls the operation of the wireless apparatus by adjusting an interval between transmissions of the interfering wave.
